(19) United States
(12) Patent Application Publication
(10) Pub. No.: US 2025/0178674 A1
(43) Pub. Date: Jun. 5, 2025

(54) LATCH DEVICE FOR FRONT HOOD

(71) Applicant: Mitsui Kinzoku Act Corporation, Yokohama-shi (JP)

(72) Inventors: Minetaka KATAGAWA, Kanagawa (JP); Kosuke ANDO, Kanagawa (JP)

(73) Assignee: Mitsui Kinzoku Act Corporation, Yokohama-shi (JP)

(21) Appl. No.: 18/967,501

(22) Filed: Dec. 3, 2024

(30) Foreign Application Priority Data
Dec. 4, 2023 (JP) 2023-204819

(51) Int. Cl. B62D 25/12; E05B 81/22; E05B 81/68

(52) U.S. Cl. CPC B62D 25/12; E05B 81/22; E05B 81/68

(57) ABSTRACT

A latch device for a front hood including: a latch that meshes with the striker provided in the front hood; a primary pawl that engages with the latch to maintain the front hood at a full-close position; a secondary pawl that engages with the latch to maintain the front hood at a half-engaged position; a motor; and a driving force transmission member that operates by driving the motor and capable of releasing engaged states between the latch and the primary pawl and between the latch and the secondary pawl, in which a closer component mounting portion is provided between the driving force transmission member and the latch, the closer component mounting portion being capable of mounting a closer component thereon that allows the latch device to perform, by driving the motor, a closer function of moving the front hood from the half-engaged position to the full-close position.

### CROSS REFERENCE TO RELATED APPLICATIONS

This application claims priority to Japanese Patent Application No. 2023-204819 filed on Dec. 4, 2023, the content of which is incorporated herein by reference.

### TECHNICAL FIELD

The present disclosure relates to a latch device for a front hood.

### BACKGROUND ART

This section provides background information related to latch devices and is not necessarily prior art to the latch device of the present disclosure. In some vehicles such as an electric automatic vehicle and a rear engine automatic vehicle in which an engine is mounted behind a vehicle body, a front of the vehicle body is used as a front trunk (also referred to as a frunk). The front hood that opens and closes the frunk is appropriately locked by the latch device (for example, U.S. Pat. No. 11,414,904 B and KR 102167840 B).

U.S. Pat. No. 11,414,904 B discloses a latch device including a ratchet that meshes with a striker provided in a front hood, and a primary pawl and a secondary pawl that can engage with the ratchet. U.S. Pat. No. 11,414,904 B discloses that the latch device releases the engagement between the ratchet and the pawl by driving an actuator to release the lock of the hood.

Further, KR 102167840 B discloses a latch device including a disk unit that is engaged with a striker and a pawl that is engageable with the disk unit. The latch device of KR 102167840 B can lock and unlock the hood by engaging or disengaging the disk unit and the pawl by driving a motor drive unit.

### SUMMARY OF INVENTION

According to an aspect of the present disclosure, there is provided a latch device for a front hood, which is capable of meshing with a striker provided in the front hood of a vehicle and performing opening and closing control of the front hood, the latch device including:
a latch configured to mesh with the striker when the front hood is in a closed state and biased by a biasing member in a direction in which the latch is to be released from meshing with the striker;
a primary pawl configured to engage with the latch to maintain the front hood at a full-close position when the latch meshing with the striker is arranged at a predetermined primary latch position;
a secondary pawl configured to engage with the latch to maintaining the front hood at a half-engaged position when the latch released from the engaged state with the primary pawl is arranged at a predetermined secondary latch position;
a motor; and
a driving force transmission member configured to operate by driving the motor and capable of releasing an engaged state between the latch and the primary pawl and an engaged state between the latch and the secondary pawl, in which
the latch device is configured to perform, by driving the motor, a power release function of releasing the engaged state between the latch and the primary pawl and the engaged state between the latch and the secondary pawl using the driving force transmission member to switch the front hood from the full-close position to a full-open position, and
a closer component mounting portion is provided between the driving force transmission member and the latch, the closer component mounting portion being capable of mounting a closer component thereon that allows the latch device to perform, by driving the motor, a closer function of moving the front hood from the half-engaged position to the full-close position.

### BRIEF DESCRIPTION OF DRAWINGS

FIG. 1 is a side view of a vehicle to which a latch device for a front hood according to an embodiment of the present disclosure is applied.

FIG. 2 is a perspective view of the latch device as viewed from a base plate side.

FIG. 3 is a perspective view of the latch device as viewed from a case side.

FIG. 4 is an exploded perspective view of a housing member.

FIG. 5 is a diagram showing an internal configuration of a latch device (with a closer and power release specification).

FIG. 6 is a view showing an actuator unit accommodated in an actuator housing.

FIG. 7 is a diagram showing a positional relation among a latch, a primary pawl, a secondary pawl, and an open lever, and a circuit board.

FIG. 8 is a block diagram showing a control system of the latch device.

FIG. 9 is a diagram sequentially showing an operation of the latch device when a closing operation of the front hood is manually performed.

FIG. 10 is a diagram sequentially showing an operation of the latch device when a closer function is executed.

FIG. 11 is a timing chart showing operation timings of a latch sensor, a primary pawl sensor, a secondary pawl sensor, a motor neutral sensor, and a motor rotation direction during the execution of the closer function shown in FIG. 10.

FIG. 12 is a diagram sequentially showing an operation of the latch device when a power release function is executed from a state where the front hood is at a full-close position.

FIG. 13 is a diagram sequentially showing an operation of the latch device when the power release function is executed from a state where the front hood is at a half-engaged position.

FIG. 14 is a timing chart showing operation timings of the latch sensor, the primary pawl sensor, the secondary pawl sensor, the motor neutral sensor, the motor rotation direction, and a command transmission unit during the execution of the power release function shown in FIG. 12.

FIG. 15 is a diagram showing an internal configuration of the latch device (with a power release specification) in a state where a closer component is removed.

FIG. 16 is a view of the latch device in a state where the closer component is mounted, as viewed from the base plate side.

FIG. 17 is a diagram sequentially showing an operation of the latch device when a stacked state of a cinching lever is released.

FIG. 18 is a perspective view of an emergency lever and the cinching lever.

### DESCRIPTION OF EMBODIMENTS

Hereinafter, a latch device for a front hood according to an embodiment of the present disclosure will be described in detail with reference to the drawings.

### Overall Configuration of Latch Device for Front Hood

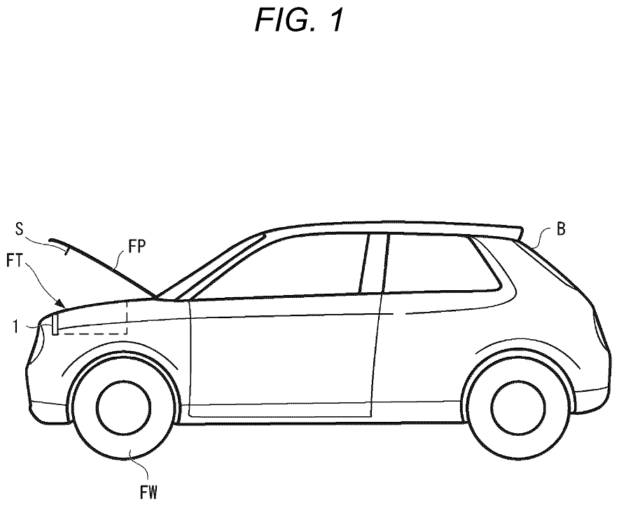

As shown in FIG. 1, a latch device 1 for a front hood (also simply referred to as a latch device 1) is applied to a four-wheel automatic vehicle such as an electric automatic vehicle including a front trunk (hereinafter referred to as a frunk FT) between left and right front wheels FW in front of a vehicle body B, and performs opening and closing control of a front hood FP that opens and closes an upper opening of the frunk FT. In the present embodiment, a striker S is provided at a lower portion of a front edge of the front hood FP. The latch device 1 performs control such that the front hood FP is maintained in a closed state or the frunk FT is opened with respect to the vehicle body B by switching between a state of meshing with the striker S and a state of releasing the meshing. Hereinafter, a specific configuration of the latch device 1 will be described in detail. In the following description, for the sake of convenience, each direction is specified in a posture of being mounted on the vehicle body B.

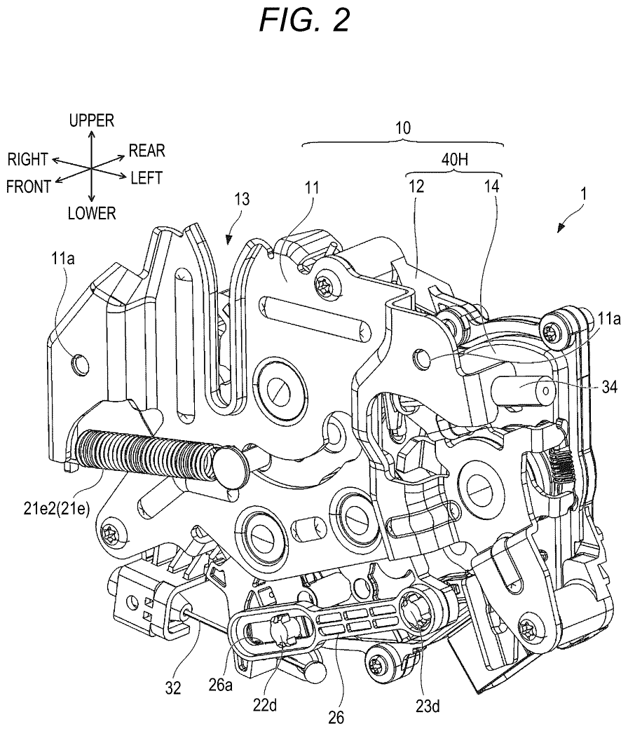

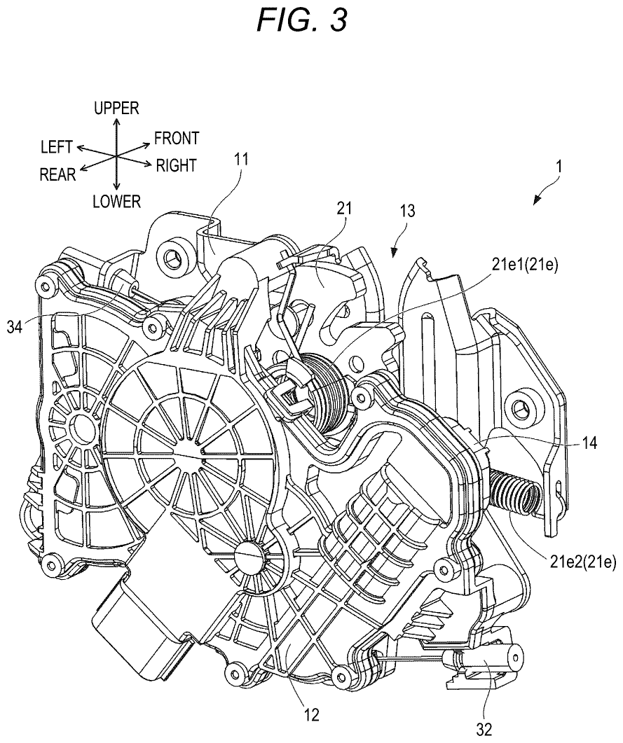

As shown in FIGS. 2 to 6, the latch device 1 includes a housing member 10, a latch 21, a primary pawl 22, a secondary pawl 23, an emergency lever 24, and an open lever 35. The housing member 10 includes a base plate 11, a case 12, and a cover 14. The case 12 accommodates an actuator unit 40 described later and is covered with the cover 14. The case 12 and the cover 14 forms an actuator housing 40H that accommodates the actuator unit 40. The base plate 11 has a plate shape formed of steel. The base plate 11 is provided to face the cover 14 and is fixed to the case 12. The latch 21, the primary pawl 22, the secondary pawl 23, the emergency lever 24, and the open lever 35 are arranged between the base plate 11 and the cover 14. In the base plate 11, a striker entrance groove 13 is formed on one side of an upper portion. The striker entrance groove 13 is a notch into which the striker S enters when the front hood FP is closed with respect to the frunk FT, and is formed to extend along a vertical direction and open at an upper edge of the base plate 11. A dimension of the striker entrance groove 13 is formed to a length that allows the front hood FP to be arranged at a full-close position with respect to the frunk FT.

When the latch device 1 is attached to the vehicle body B, the base plate 11 is arranged on a vehicle front side, and the actuator housing 40H is arranged on a vehicle rear side. The base plate 11 is provided with vehicle body attachment portions 11a at both left and right end portions, and is attached to the vehicle body B via fastening members such as bolts. Since the base plate 11 is disposed on the vehicle front side, an ease of assembly and an ease of attachment to the vehicle body B of a frunk cable 32 and an emergency cable 34 described below are improved. When a load collides with the latch device 1 when being loaded into the frunk FT, since the load collides with the base plate 11 first, the actuator unit 40 accommodated in the actuator housing 40H is protected. The latch device 1 thus attached to the vehicle body B can stably operate for a long time.

The latch 21, the primary pawl 22, the secondary pawl 23, and the emergency lever 24 are supported by the base plate 11 via respective support shafts, and can rotate about axes parallel to each other. In the shown example, the support shaft (hereinafter, referred to as a latch shaft 21a) of the latch 21 is provided on a side of the striker entrance groove 13. The support shaft of the primary pawl 22 (hereinafter referred to as a primary shaft 22a) is provided below the latch shaft 21a around the latch 21, and the support shaft of the secondary pawl 23 (hereinafter referred to as a secondary shaft 23a) is provided between the latch shaft 21a and the primary shaft 22a around the latch 21. A support shaft of the emergency lever 24 (hereinafter, referred to as an emergency support shaft 24a) is provided at a position farther from the latch 21 than the secondary shaft 23a.

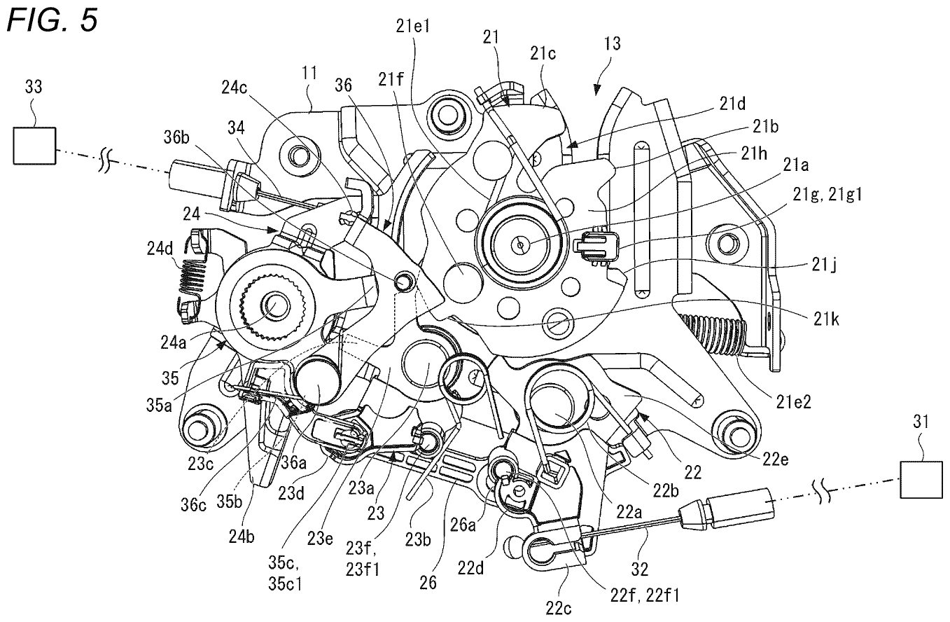

The latch 21 meshes with the striker S, and has a striker abutting portion 21b and a hook portion 21c at an outer peripheral portion thereof. The striker abutting portion 21b and the hook portion 21c extend from the latch shaft 21a in a radial direction, can be arranged to cross the striker entrance groove 13 of the base plate 11, and adjacent to each other with an accommodation groove 21d capable of accommodating the striker S therebetween. A latch spring 21e including a first latch spring 21e1 which is a torsion coil spring and a second latch spring 21e2 which is a tension coil spring is provided between the latch 21 and the base plate 11. The latch 21 is always biased in a release direction (counterclockwise direction in FIG. 5) to return to a predetermined meshing standby state by a biasing force of the latch spring 21e provided between the latch 21 and the base plate 11. The meshing standby state is a state in which the hook portion 21c is retracted laterally with respect to the striker entrance groove 13, the striker abutting portion 21b is arranged at a position crossing the striker entrance groove 13, and an opening of the accommodation groove 21d is aligned with the striker entrance groove 13. Therefore, in the meshing standby state, when the front hood FP gets closed, the striker S can enter the striker entrance groove 13. When the front hood FP further moves in a closing direction, the striker S entering the striker entrance groove 13 abuts against the striker abutting portion 21b, so that the latch 21 rotates in a meshing direction (clockwise direction in FIG. 5) against the biasing force of the latch spring 21e, and the hook portion 21c is arranged in a state of crossing an opening end portion side of the striker entrance groove 13 in a state where the striker S is accommodated in the accommodation groove 21d.

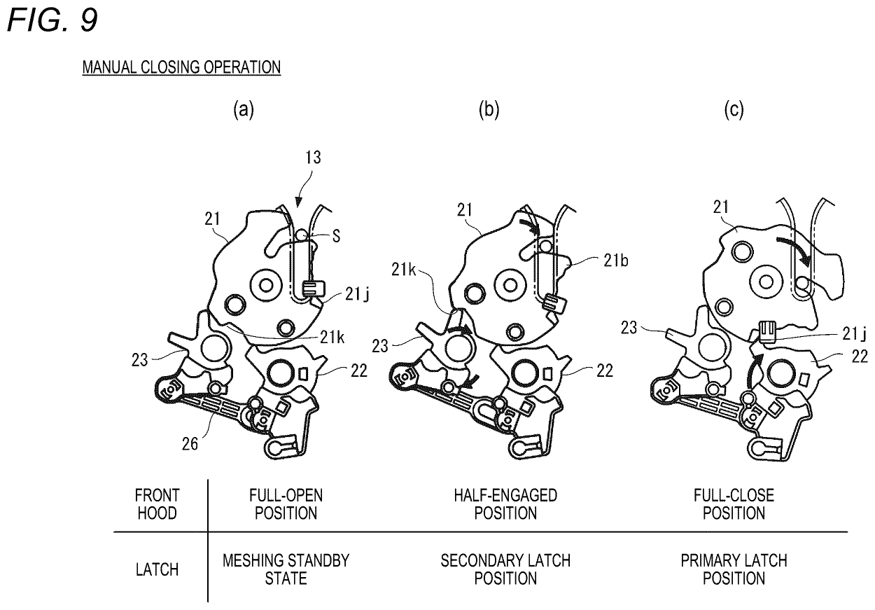

The latch 21 is provided with a latch pin mounting portion 21f1 and a magnet mounting portion 21g1, and a latch pin 21f and a latch detection magnet 21g are mounted to respective mounting portions. The latch pin 21f protrudes toward the case 12 from a surface of the latch 21 facing the case 12 (hereinafter referred to as a cover facing surface 21h), and is provided at a portion above the latch shaft 21a when the latch 21 is arranged at a primary latch position (see (c) of FIG. 9). The primary latch position of the latch 21 is a position where the hook portion 21c is arranged across the striker entrance groove 13 in a state where the accommodation groove 21d of the latch 21 is positioned at a lower portion of the striker entrance groove 13. The latch detection magnet 21g is for detecting a rotation state of the latch 21 by a latch sensor 51 described later. In the shown example, the latch detection magnet 21g is attached to a portion of the cover facing surface 21h of the latch 21 corresponding to the latch pin 21f across the latch shaft 21a, that is, a portion below the latch shaft 21a when the latch 21 is arranged at the primary latch position.

The primary pawl 22 and the secondary pawl 23 are engaged with the latch 21 to prevent the latch 21 from rotating in the release direction against the biasing force of the latch spring 21e and stop the latch 21 at desired positions.

More specifically, when the latch 21 is arranged at the primary latch position, the primary pawl 22 engages with a primary engagement portion 21j of the latch 21 to prevent the latch 21 from rotating in the release direction. A primary spring 22b that constantly biases the primary pawl 22 in an engagement direction is provided between the primary pawl 22 and the base plate 11. The primary pawl 22 is provided with a frunk cable connection portion 22c. The frunk cable connection portion 22c extends in the radial direction and extends to a position where an extending end portion exceeds the base plate 11. A frunk cable (opening operation transmission portion) 32 that links with an in-frunk operation portion (opening operation portion) 31 is connected to the frunk cable connection portion 22c. The in-frunk operation portion 31 is an operation portion that can be operated from the inside of the frunk FT when the front hood FP is in the closed state. When the in-frunk operation portion 31 is operated, the operation force is transmitted to the primary pawl 22 via the frunk cable 32, and the primary pawl 22 can be rotated in a direction to release the engaged state with the latch 21 against the biasing force of the primary spring 22b.

The secondary pawl 23 prevents the latch 21 from rotating in the release direction by engaging with a secondary engagement portion 21k of the latch 21 when the hook portion 21c is arranged in a state of crossing the striker entrance groove 13 (secondary latch position of the latch 21) in a state where the accommodation groove 21d of the latch 21 is positioned at an upper portion of the striker entrance groove 13.

When the latch 21 is arranged at the primary latch position in a state where the striker S is accommodated in the accommodation groove 21d, the front hood FP is arranged at the full-close position with respect to the frunk FT (see (c) of FIG. 9), and when the latch 21 is arranged in the secondary latch position in a state where the striker S is accommodated in the accommodation groove 21d, the front hood FP is arranged at the half-engaged position that is a position at which the front hood FP is slightly opened with respect to the frunk FT (see (b) of FIG. 9). A secondary spring 23b that constantly biases the secondary pawl 23 in the engagement direction is provided between the secondary pawl 23 and the base plate 11. The secondary pawl 23 is provided with an actuator input portion 23c. The actuator input portion 23c abuts against the open lever 35 when the open lever 35, which will be described later, rotates in the release direction (clockwise direction in FIG. 5), and rotates the secondary pawl 23 in a direction to release the engaged state with the latch 21 against the biasing force of the secondary spring 23b.

A link bar (interlocking link portion) 26 is provided between the primary pawl 22 and the secondary pawl 23. In the shown example, one end portion of the link bar 26 is rotatably pivoted by a lever link portion 23d of the secondary pawl 23, and the other end portion of the link bar 26 is rotatably pivoted by the lever link portion 22d of the primary pawl 22 via a long hole 26a. The lever link portion 23d of the secondary pawl 23 protrudes outward from an outer peripheral surface of the secondary pawl 23, and the lever link portion 22d of the primary pawl 22 protrudes outward from an outer peripheral surface of the primary pawl 22. When the secondary pawl 23 rotates in a direction to release the meshing with the latch 21, the link bar 26 interlocks the primary pawl 22. On the other hand, when the primary pawl 22 is rotated in a direction to release the engaged state with the latch 21 by the operation force of the in-frunk operation portion 31, the link bar 26 is not interlocked due to the long hole 26a, and the state where the secondary pawl 23 is engaged with the latch 21 is maintained.

Similarly to the latch 21, a magnet mounting portion 22f1 is provided on a cover facing surface 22e of the primary pawl 22, and a primary detection magnet 22f for detecting a rotation state of the primary pawl 22 by a primary pawl sensor 52 described later is mounted. A magnet mounting portion 23f1 is provided on a cover facing surface 23e of the secondary pawl 23, and a secondary detection magnet 23f for detecting a rotation state of the secondary pawl 23 by a secondary pawl sensor 53 described later is mounted.

The emergency lever 24 includes a pawl pressing portion 24b and a vehicle cabin cable connection portion 24c. The pawl pressing portion 24b and the vehicle cabin cable connection portion 24c extend in the radial direction from the emergency support shaft 24a. A lever spring 24d for biasing the emergency lever 24 in the clockwise direction in FIG. 5 and arranging the emergency lever 24 at a predetermined operation standby position is provided between the emergency lever 24 and the base plate 11. The pawl pressing portion 24b is arranged to be separated from the lever link portion 23d of the secondary pawl 23 abutting against the outer peripheral surface of the latch 21 when the emergency lever 24 is arranged at the operation standby position, and can rotate the secondary pawl 23 in the release direction by abutting against the lever link portion 23d when the emergency lever 24 rotates in the counterclockwise direction in FIG. 5 against the biasing force of the lever spring 24d. The emergency cable 34 is connected to the vehicle cabin cable connection portion 24c to link with an in-vehicle-cabin operation portion (operation portion for emergency) 33. The in-vehicle-cabin operation portion 33 is an operation portion provided at a position where the operation is disabled in a state where the vehicle is traveling in a vehicle cabin, for example, on the back side of a foot of a driver seat. When the in-vehicle-cabin operation portion 33 is operated, the operation force is transmitted to the secondary pawl 23 via the emergency cable 34 and the emergency lever 24, and the secondary pawl 23 can be rotated in the direction to release the engaged state with the latch 21 against the biasing force of the secondary spring 23b.

The open lever 35 is fixed to a boss portion 47a of a sector gear 47 described later, and rotates integrally with the sector gear 47, and thus operates by driving an electric motor 41. The open lever 35 is an example of a driving force transmission member of the present disclosure. Details of the open lever 35 will be described later.

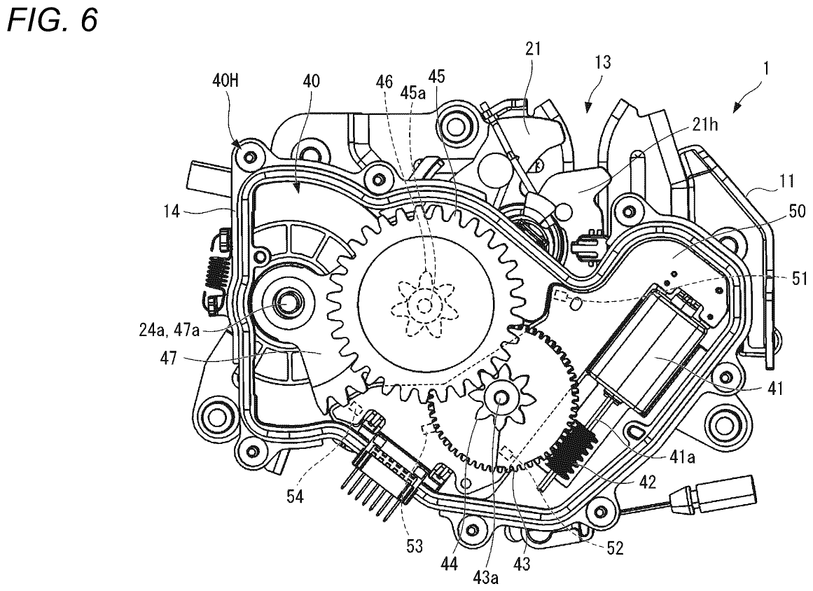

As shown in FIG. 6, the actuator housing 40H is provided with the actuator unit 40 and a circuit board 50.

The actuator unit 40 includes the electric motor 41 capable of rotating forward and backward, and a speed reduction mechanism that reduces a speed of the drive of the electric motor 41 and transmits the drive to the open lever 35. The speed reduction mechanism includes a worm gear 42 provided on an output shaft 41a of the electric motor 41, a first gear (worm wheel) 43 that meshes with the worm gear 42, a third gear 45 that meshes with a second gear 44 provided integrally with the first gear 43, and the sector gear 47 that meshes with a fourth gear 46 provided integrally with the third gear 45. The first gear 43 and the third gear 45 are rotatably supported by the actuator housing 40H via individual support shafts 43a and 45a parallel to the latch shaft 21a. The electric motor 41 is disposed at a portion on an outer peripheral side of the latch 21, and the first gear 43 and the third gear 45 are arranged at positions overlapping the cover facing surface 21h of the latch 21. The sector gear 47 is rotatably supported by the actuator housing 40H via a cylindrical boss portion 47a provided at a center portion. The boss portion (output portion) 47a of the sector gear 47 is provided at a portion on the outer peripheral side of the latch 21 to coincide with the emergency support shaft 24a.

Referring back to FIG. 5, the open lever 35 is fixed to the boss portion 47a of the sector gear 47 and rotates integrally with the sector gear 47, and thus has a pressing lever portion 35a and a cinching coupling portion 35b. The pressing lever portion 35a extends in the radial direction from a rotation axis of the open lever 35, and an extending edge portion thereof is bent toward the base plate 11. When the open lever 35 is arranged at a predetermined neutral position, the pressing lever portion 35a is positioned above the actuator input portion 23c provided in the secondary pawl 23. When the electric motor 41 rotates in an open direction from the neutral position, the open lever 35 rotates in the release direction (clockwise direction in FIG. 5), and rotates the secondary pawl 23 in the direction to release the engaged state with the latch 21 via the actuator input portion 23c.

The cinching coupling portion 35b extends in the radial direction from the rotation axis of the open lever 35. When the open lever 35 is arranged at the neutral position, the cinching coupling portion 35b extends downward from the rotation axis of the open lever 35. A cinching lever 36 is rotatably coupled to the cinching coupling portion 35b via a cinching support shaft 36a such as a rivet. The cinching lever 36 is an example of a link mechanism of the present disclosure. The cinching support shaft 36a extends parallel to the rotation axis of the open lever 35.

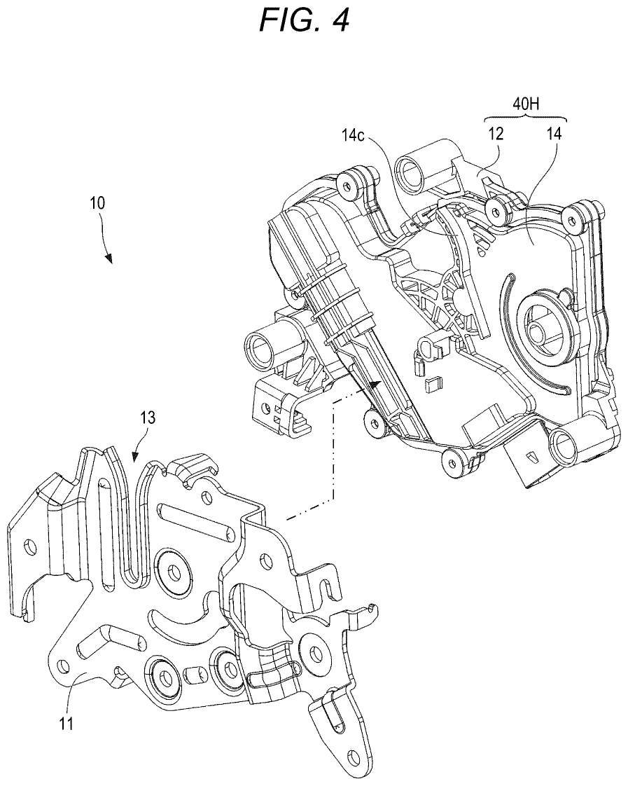

The cinching lever 36 extends from the cinching coupling portion 35b toward the latch pin 21f of the latch 21, and is biased in the clockwise direction in FIG. 5 by a cinching lever spring 36c with the cinching support shaft 36a as a rotation axis. The cinching lever 36 includes a guide pin 36b at a distal end portion thereof. The guide pin 36b protrudes from the cinching lever 36 toward the cover 14. The cover 14 is provided with a guide rib 14c (see FIG. 4). The guide rib 14c guides movement of the cinching lever 36 via the guide pin 36b when the open lever 35 rotates, and is formed integrally with the cover 14. The guide rib 14c is provided so that, when the open lever 35 rotates in a cinching direction (counterclockwise direction in FIG. 5), the latch 21 can be rotated to the primary latch position against the biasing force of the latch spring 21e by bringing an extending end surface of the cinching lever 36 to abut against the latch pin 21f.

The open lever 35 is provided with a magnet mounting portion 35c1, and an open lever detection magnet 35c for detecting a posture of the open lever 35 by a motor neutral sensor 54 described later is mounted on the magnet mounting portion 35c1.

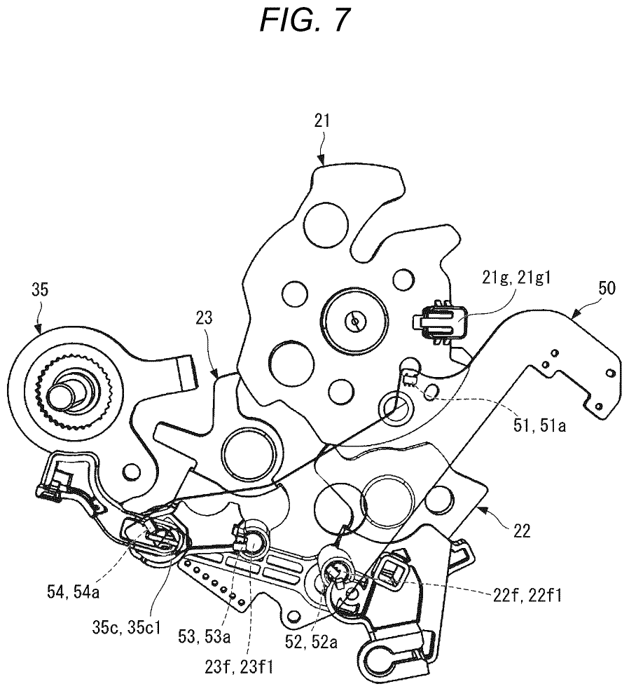

As shown in FIGS. 6 and 7, the circuit board 50 is, for example, a printed circuit board, and is arranged inside the actuator housing 40H. The circuit board 50 has a size including all portions where the latch detection magnet 21g, the primary detection magnet 22f, the secondary detection magnet 23f, and the open lever detection magnet 35c are provided, and is arranged at a position where the circuit board 50 overlaps at least a portion of the latch 21, the primary pawl 22, and the secondary pawl 23 in an axial direction of the latch shaft 21a. The circuit board 50 is provided with a sensor mounting portion to which the magnet sensor is mounted, and the magnet sensor is arranged in the sensor mounting portion. The magnet sensor includes the latch sensor 51 which detects whether the latch 21 is in the primary latch position, the primary pawl sensor 52 which detects whether the primary pawl 22 is engaged with the latch 21, the secondary pawl sensor 53 which detects whether the secondary pawl 23 is engaged with the latch 21, and the motor neutral sensor 54 which detects whether the open lever 35 is in the neutral position. The circuit board 50 is provided with sensor mounting portions 51a, 52a, 53a, and 54a on which the sensors 51, 52, 53, and 54 are mounted. On the circuit board 50, a processing device such as a central processing unit (CPU) or hardware such as an integrated circuit (IC) is mounted constituting the controller 100 described later.

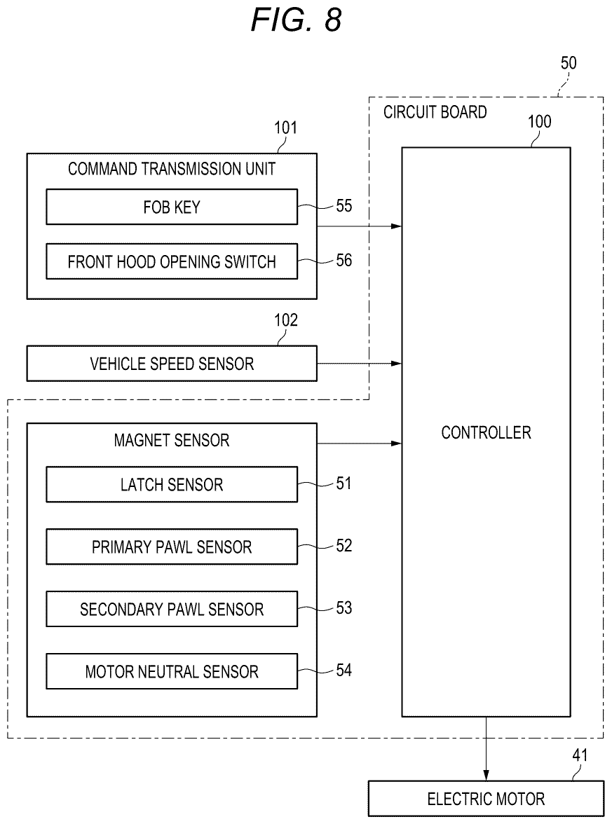

FIG. 8 shows a control system of the latch device 1. A controller 100 controls driving of the electric motor 41 in accordance with a program or data stored in a memory when the controller 100 receives output signals from a command transmission unit 101, a vehicle speed sensor 102, the latch sensor 51, the primary pawl sensor 52, the secondary pawl sensor 53, and the motor neutral sensor 54. The command transmission unit 101 is for outputting an open command to the controller 100 when the frunk FT is opened, and includes, for example, a front hood opening switch 56 provided in a vehicle cabin, and a frequency operated button (FOB) key 55 possessed by an owner of the vehicle. The vehicle speed sensor 102 detects a speed of the vehicle and outputs the detection result to the controller 100. The controller 100 may be implemented, for example, by causing a processing device such as a CPU to execute a program, that is, by software, by hardware such as an IC, or by a combination of software and hardware.

### Operation of Latch Device

Next, the operation of the latch device 1 will be described with reference to FIGS. 9 to 14.

### Closing Operation of Front Hood FP

First, the closing operation of the front hood FP that is manually performed will be described with reference to FIG. 9. In FIG. 9, the open lever 35 and the cinching lever 36 are not shown.

When the front hood FP is arranged at a position where an opening of the frunk FT is opened, as shown in (a) of FIG. 9, the latch 21 is positioned in the meshing standby state by the latch spring 21e, and the open lever 35 is arranged at the neutral position. At this time, as described above, the primary pawl 22 and the secondary pawl 23 are biased in the engagement direction by the primary spring 22b and the secondary spring 23b, respectively, in a state of abutting against the outer peripheral surface of the latch 21.

When the front hood FP is operated to close the opening of the frunk FT from the above-described state while the vehicle is stopped, as shown in (b) of FIG. 9, the striker S enters the striker entrance groove 13, and the striker S abuts against the striker abutting portion 21b of the latch 21. At this time, the secondary pawl 23 engages with the secondary engagement portion 21k of the latch 21, so that the latch 21 is prevented from moving in the release direction, and the latch 21 is arranged at the secondary latch position. As a result, even when the operation force to the front hood FP is removed, the front hood FP is maintained at the half-engaged position where the front hood FP is slightly opened with respect to the frunk FT.

When the front hood FP is further moved in the closing direction from this state, the latch 21 rotates in the meshing direction against the biasing force of the latch spring 21e, and as shown in (c) of FIG. 9, the front hood FP reaches the full-close position where the opening of the frunk FT is completely closed. At this time, the primary pawl 22 engages with the primary engagement portion 21j of the latch 21, so that the latch 21 is prevented from moving in the release direction, and the latch 21 is arranged at the primary latch position. As a result, the front hood FP is maintained at the full-close position where the frunk FT is closed.

### Closer Function

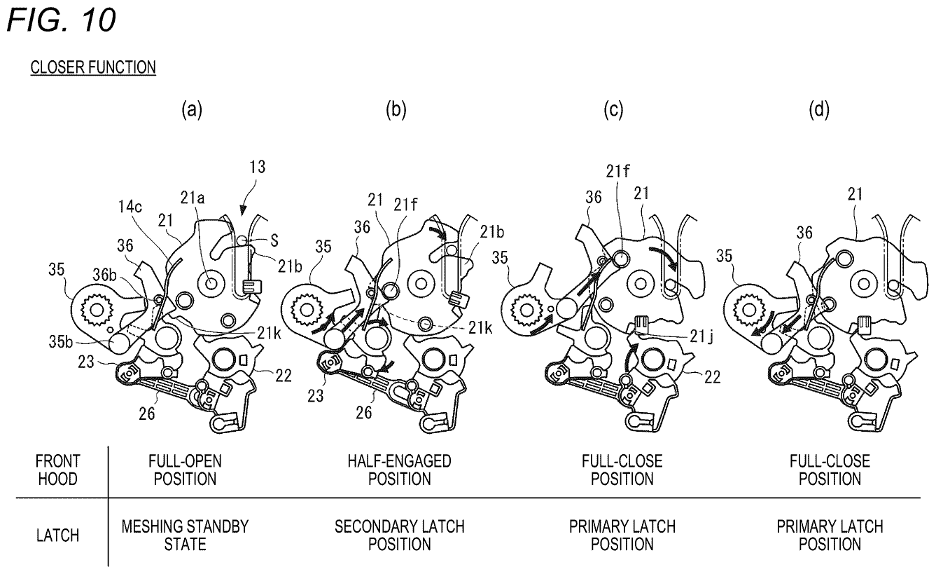

When the front hood FP is moved to close halfway from the full-open position of the front hood FP shown in (a) of FIG. 10 and the front hood FP is arranged at the half-engaged position as shown in (b) FIG. 10, the latch 21 is arranged at the secondary latch position, and the secondary pawl 23 is engaged with the secondary engagement portion 21k of the latch 21, whereby the movement in the release direction is prevented. As a result, the front hood FP is maintained at the half-engaged position.

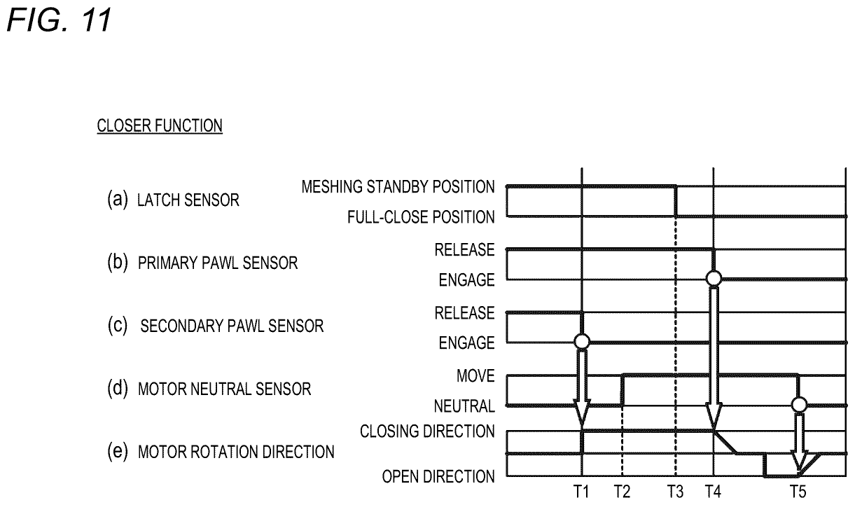

When detecting that the latch 21 moves from the meshing standby state to the secondary latch position due to switching of a detection state of the secondary pawl sensor 53, the controller 100 performs cinching processing and drives the electric motor 41 in the closing direction (time T1 in FIG. 11). As a result, the open lever 35 rotates in the cinching direction (time T2 in FIG. 11), and the cinching lever 36 presses the latch pin 21f, so that the rotation of the open lever 35 proceeds. Therefore, the cinching lever 36 moves along the guide rib 14c via the guide pin 36b, and the latch 21 is arranged at the primary latch position. Accordingly, as shown in (c) of FIG. 10, the primary pawl 22 is engaged with the primary engagement portion 21j of the latch 21, and the movement in the release direction is prevented, and thus the front hood FP is maintained at the full-close position where the frunk FT is closed (time T3 in FIG. 11).

When the primary pawl sensor 52 detects that the latch 21 is arranged at the primary latch position, the controller 100 drives the electric motor 41 in the open direction until the open lever 35 returns to the neutral position as shown in (d) of FIG. 10 (time T4 in FIG. 11). When the motor neutral sensor 54 detects that the open lever 35 returns to the neutral position, the controller 100 stops the driving of the electric motor 41 (time T5 in FIG. 11).

The function of moving the front hood FP from the half-engaged position to the full-close position by the driving of the electric motor 41 described above is also referred to as a closer function. According to the closer function, when the front hood FP is operated to be closed from the open state to the half-engaged position, the latch device 1 operates to the full-close position of the front hood FP, which is advantageous in terms of operability.

Further, the cinching lever 36 is rotatably supported by the cinching coupling portion 35b of the open lever 35, and is formed as a link member forming a link mechanism with the open lever 35. Accordingly, a retraction force for retracting the striker S can be easily adjusted by appropriately changing an extension length from the cinching coupling portion 35b. In addition, since the cinching lever 36 is moved along the guide rib 14c provided on the cover 14, a retraction path of the striker S can be easily adjusted by appropriately changing a path of the guide rib 14c. Furthermore, since the cinching lever 36 is arranged to overlap the latch 21 in a direction along the latch shaft 21a, transmission loss can also be reduced.

### Power Release Function

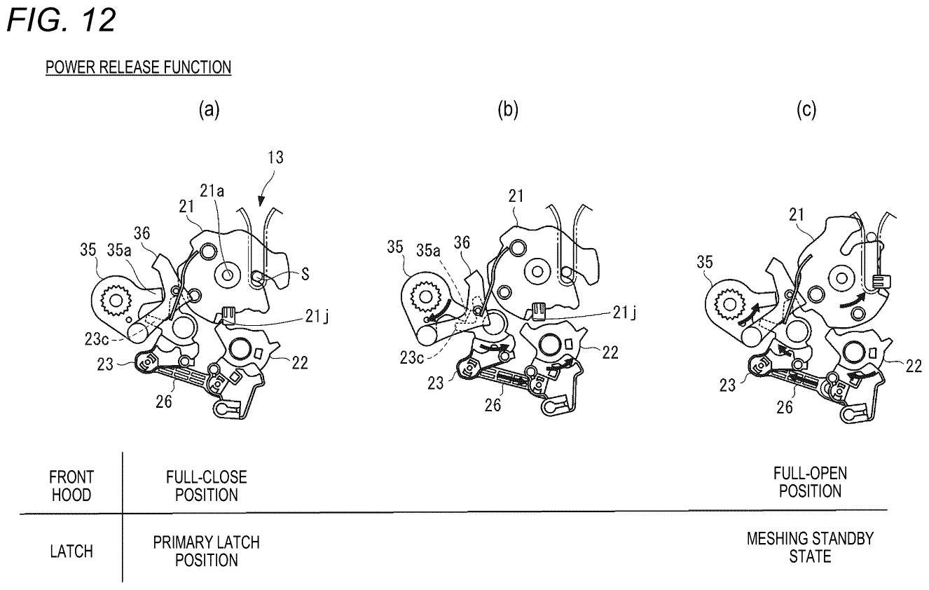

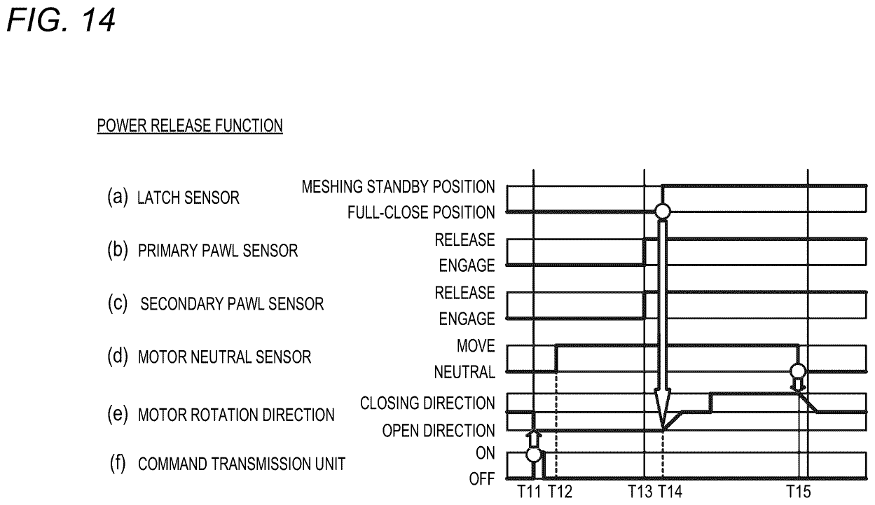

As shown in (a) of FIG. 12, when the command transmission unit 101 is operated in a state where the latch 21 meshing with the striker S is at the primary latch position and the opening of the frunk FT is closed by the front hood FP (time T11 in FIG. 14), the controller 100 that detects that the open command is given performs open processing, determines whether or the vehicle is traveling through the vehicle speed sensor 102, and drives the electric motor 41 in the open direction on a condition that the vehicle is stopped.

As shown in (b) of FIG. 12, when the electric motor 41 is driven in the open direction, the open lever 35 rotates in the release direction (time T12 in FIG. 14), the secondary pawl 23 rotates in the direction to release the engaged state with the latch 21, the rotation of the secondary pawl 23 is transmitted to the primary pawl 22 via the link bar 26, and the secondary pawl 23 rotates in the release direction until the engaged state between the primary pawl 22 and the primary engagement portion 21j of the latch 21 is released (time T13 in FIG. 14).

As a result, as shown in (c) of FIG. 12, the latch 21 rotates to the meshing standby state by the biasing force of the latch spring 21e, and the front hood FP reaches the full-open position (time T14 in FIG. 14). As described above, when the command transmission unit 101 is operated only once, the front hood FP can be opened to open the frunk FT, and the load can be easily taken in and out of the frunk FT.

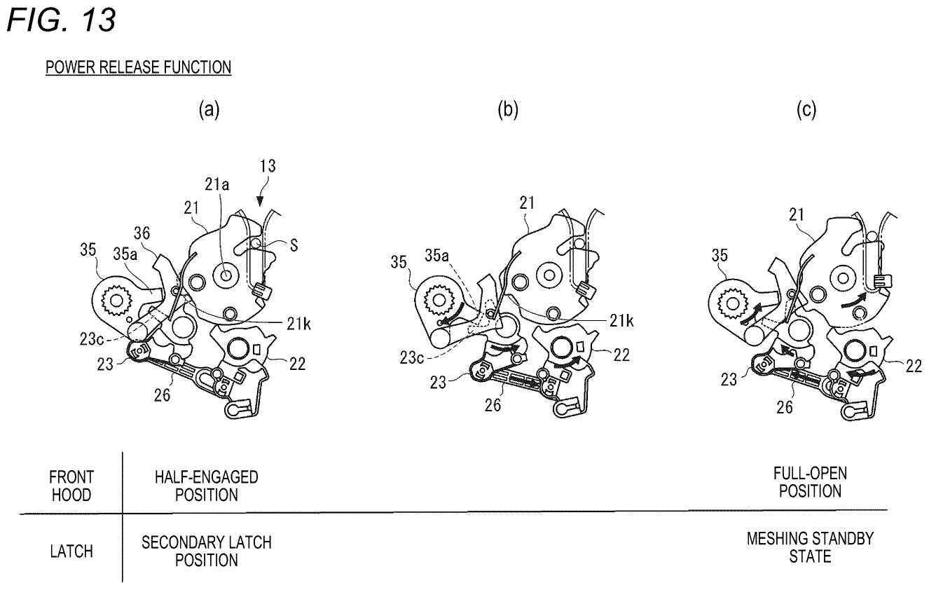

As shown in (a) to (c) of FIG. 13, the above-described operation is similarly performed even when the open command is output from the command transmission unit 101 in a case where the latch 21 meshing with the striker S is at the secondary latch position, and when the electric motor 41 is driven in the open direction on a condition that the vehicle is not traveling, the front hood FP can be opened to open the frunk FT.

When the latch sensor 51, the primary pawl sensor 52, and the secondary pawl sensor 53 are switched to detect that the latch 21 is arranged in the meshing standby state, the controller 100 drives the electric motor 41 in the closing direction until the open lever 35 returns to the neutral position as shown in (c) of FIG. 12 and (c) of FIG. 13 (time T14 in FIG. 14). When the motor neutral sensor 54 detects that the open lever 35 returns to the neutral position, the controller 100 stops the driving of the electric motor 41 (time T15 in FIG. 14).

Such a function of moving the front hood FP from the full-close position to the full-open position by the driving of the electric motor 41 is also referred to as a power release function.

On the other hand, when it is determined that the vehicle is traveling when the open command is output from the command transmission unit 101, the controller 100 maintains the open lever 35 at the neutral position without driving the electric motor 41. Therefore, even when the command transmission unit 101 is erroneously operated while the vehicle is traveling, the front hood FP is not brought into a full-open state without preparation, and there is no concern that a problem such as the front field of view being blocked by the front hood FP during traveling is caused.

As described above, the latch device 1 has the closer function and the power release function. These two functions are realized by allowing the electric motor 41 to rotate forward and backward.

### Specification Change of Latch Device

The latch device 1 can change a closer and power release specification and a power release specification. The closer and power release specification has the closer function described above and the power release function. The power release specification is a specification having the power release function without having the closer function, and is changed from the closer and power release specification to the power release specification by removing a predetermined closer component from the latch device 1 of the closer and power release specification.

The closer component is a component for realizing the closer function, and in the latch device 1 described above, the cinching lever 36, the cinching support shaft 36a, the guide pin 36b, the cinching lever spring 36c, and the latch pin 21f are examples of the closer component.

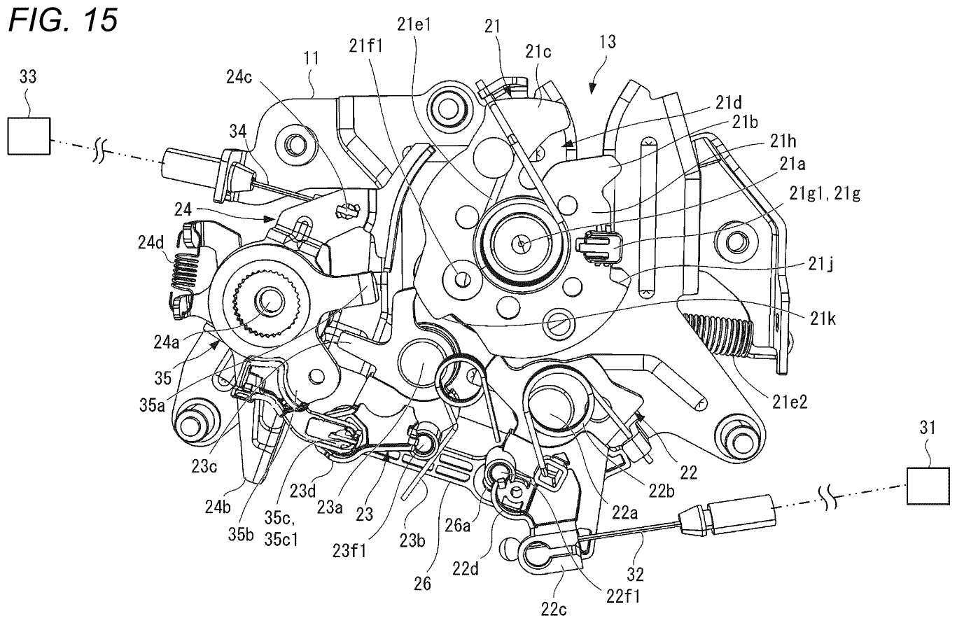

FIG. 15 is a view of the latch device 1 from which the closer component is removed. As shown in FIGS. 12 and 13, the closer component does not act on the latch 21, the primary pawl 22, or the secondary pawl 23 when the power release function is executed, and thus the latch device 1 can have the power release function even in a state where the closer component is removed.

In other words, since the latch device 1 is provided with the closer component mounting portion to which the closer component is mounted, it is possible to select the power release specification or the closer and power release specification depending on whether the closer component is mounted. Here, in the latch device 1 described above, the cinching coupling portion 35b which is provided in the open lever 35 and to which the cinching lever 36 is mounted and the latch pin mounting portion 21f1 which is provided in the latch 21 and to which the latch pin 21f is mounted are examples of the closer component mounting portion.

As described above, when the latch device 1 is changed from the closer and power release specification to the power release specification, the change can be made only by removing the closer component without providing a dedicated component. In any of the specifications, components other than the closer component are shared, and thus two specifications can be created at a low cost in the same housing, that is, the latch device 1 can handle the specification change between the power release specification and the closer and power release specification at a low cost. In addition, since the housing member 10 is common to any of the specifications, for example, when a grade adopting the closer and power release specification and a grade adopting the power release specification are prepared in a certain vehicle type, it is not necessary to design and change a vehicle body portion on which the latch device 1 is mounted according to the grade. Further, since the housing member 10 is common to any of the specifications, the housing member 10 can also be used as a fixture used when assembling the latch device 1.

As shown in FIG. 7, the latch device 1 is provided with sensor mounting portions 52a and 53a to which the primary pawl sensor 52 and the secondary pawl sensor 53 can be mounted to the circuit board 50, respectively. The latch device 1 is provided with the magnet mounting portions 22f1 and 23f1 to which the primary detection magnet 22f and the secondary detection magnet 23f can be mounted, respectively.

The primary pawl sensor 52 and the secondary pawl sensor 53 are sensors that are particularly required when executing the closer function, as shown in FIG. 11, when the secondary pawl sensor 53 detects the engaged state between the secondary pawl 23 and the latch 21, the controller 100 drives the electric motor 41 in the closing direction, and when the primary pawl sensor 52 detects the engaged state between the primary pawl 22 and the latch 21, the controller 100 drives the electric motor 41 in the open direction. On the other hand, the primary pawl sensor 52 and the secondary pawl sensor 53 may not necessarily be provided when the power release function is executed. Therefore, when the latch device 1 is of the power release specification, the primary pawl sensor 52 and the secondary pawl sensor 53 are not mounted on the sensor mounting portions 52a and 53a, and the primary detection magnet 22f and the secondary detection magnet 23f are not mounted on the magnet mounting portions 22f1 and 23f1, so that a manufacturing cost of the latch device 1 of the power release specification can be further reduced. However, even in the power release specification, the primary pawl sensor 52 and the secondary pawl sensor 53 may be mounted on the sensor mounting portions 52a and 53a, and the primary detection magnet 22f and the secondary detection magnet 23f may be mounted on the magnet mounting portions 22f1 and 23f1, and in this case, the state of the latch 21 can be reliably grasped, and the control by the controller 100 can be accurately performed.

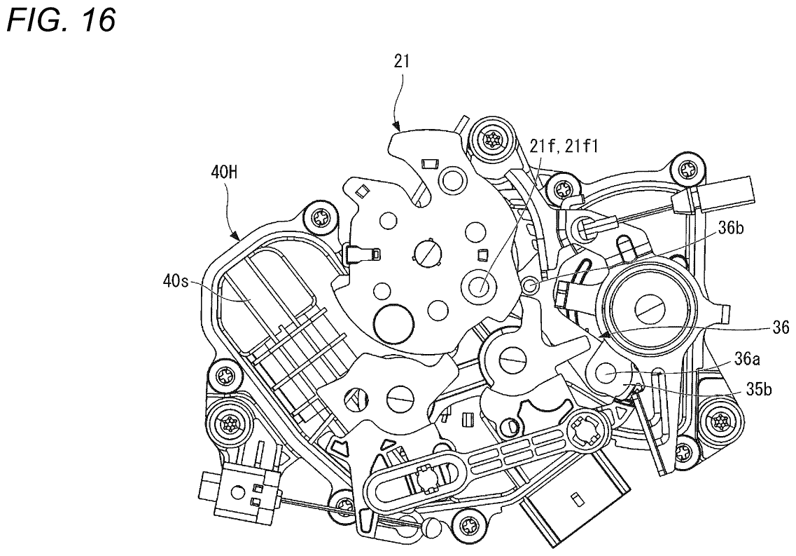

As shown in FIG. 16, the cinching coupling portion 35b and the latch pin mounting portion 21f1, which are examples of the closer component mounting portion, are provided to overlap a surface 40s (that is, a surface facing the base plate 11) having a maximum projected area among surfaces of the actuator housing 40H. Accordingly, even when the closer component is mounted on the closer component mounting portion, an increase in size of the latch device 1 can be prevented.

In particular, in the present embodiment, when the closer component is mounted on the closer component mounting portion, the entire closer component is provided to overlap the surface 40s of the actuator housing 40H. Specifically, the cinching lever 36, the cinching support shaft 36a, the guide pin 36b, the cinching lever spring 36c, and the latch pin 21f are provided so as not to protrude to the outside of the surface 40s of the actuator housing 40H. Therefore, even when the latch device 1 is of the closer and power release specification, the size of the latch device 1 is the same as that of the latch device 1 of the power release specification. Thus it is not necessary to design and change the vehicle body portion on which the latch device 1 is mounted according to the specifications of the latch device 1.

### Release of Stacked State

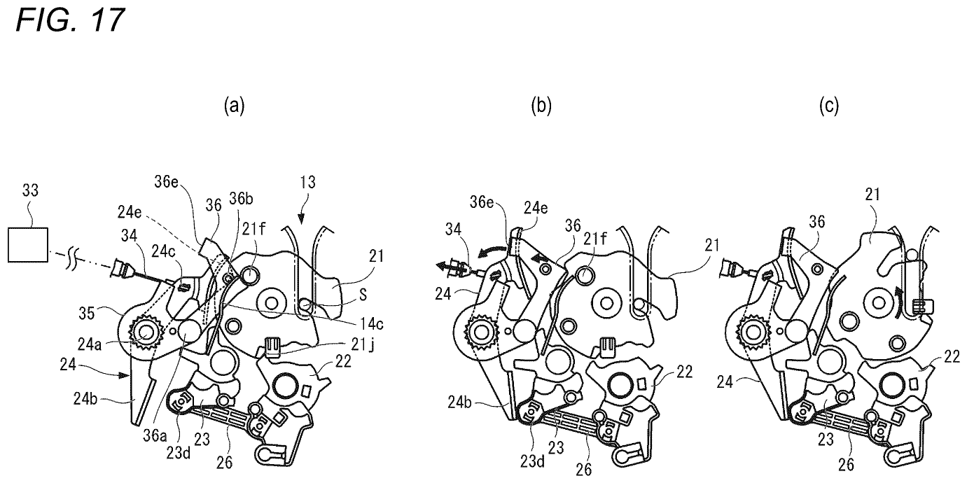

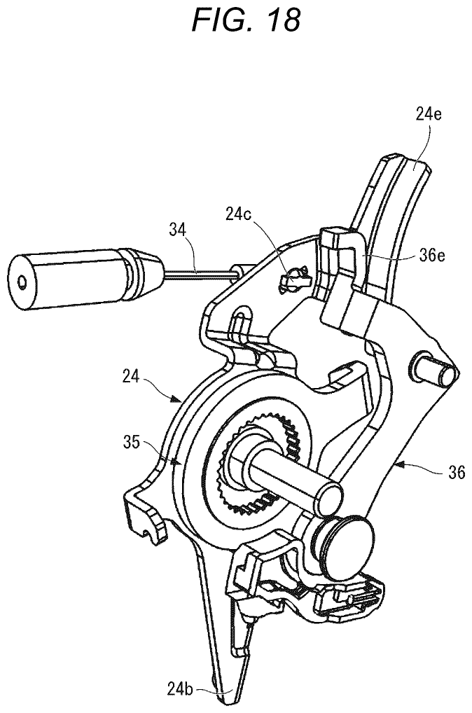

Next, an operation for releasing the stacked state that may occur when the closer function is executed in the latch device 1 of the closer and power release specification will be described with reference to FIGS. 17 and 18.

When the closer function is executed, normally, after the front hood FP reaches the full-close position ((c) of FIG. 10), the controller 100 drives the electric motor 41 in the open direction until the open lever 35 returns to the neutral position ((d) of FIG. 10). However, some failure or the like may occur, as shown in (a) of FIG. 17, after the front hood FP reaches the full-close position, the electric motor 41 may not be driven in the open direction, and the cinching lever 36 may abut against and engage with the latch pin 21f (stacked state).

This stacked state is released by operating the in-vehicle-cabin operation portion 33. Specifically, the emergency lever 24 and the cinching lever 36 have an engaging portion 24e and an engaged portion 36e that engage with each other when the in-vehicle-cabin operation portion 33 is operated. As shown in (b) of FIG. 17, when the in-vehicle-cabin operation portion 33 is operated and the operation force thereof rotates the emergency lever 24 counterclockwise via the emergency cable 34, the engaging portion 24e of the emergency lever 24 and the engaged portion 36e of the cinching lever 36 are engaged with each other, and the cinching lever 36 is pulled into the emergency lever 24 and is separated from the latch pin 21f. As a result, the engaged state between the cinching lever 36 and the latch pin 21f is released. At this time, the pawl pressing portion 24b abuts against the lever link portion 23d of the secondary pawl 23, and rotates the primary pawl 22 via the secondary pawl 23 and the link bar 26 in the direction to release the engaged state with the latch 21. Accordingly, as shown in (c) of FIG. 17, the engaged state between the primary pawl 22 and the primary engagement portion 21j of the latch 21 is released, and the latch 21 rotates in the release direction to return to the meshing standby state. In this way, the stacked state is released.

Although an embodiment of the present disclosure has been described above with reference to the accompanying drawings, it is needless to say that the present disclosure is not limited to the embodiment. It is apparent to those skilled in the art that various modifications or corrections can be conceived within the scope described in the claims, and it is understood that the modifications or corrections naturally fall within the technical scope of the present disclosure. Components in the above embodiments may be freely combined without departing from the gist of the disclosure.

The present specification describes at least the following matters. Corresponding components and the like in the above-described embodiments are described in parentheses as an example, and the present disclosure is not limited thereto.

(1) A latch device (the latch device 1) for a front hood (front hood FP), which is capable of meshing with a striker (the striker S) provided in the front hood of a vehicle and performing opening and closing control of the front hood, the latch device including:
a latch (the latch 21) that meshes with the striker when the front hood is in a closed state and is biased by a biasing member (the latch spring 21e) in a direction in which the latch is to be released from the meshing with the striker;
a primary pawl (the primary pawl 22) that engages with the latch to maintain the front hood at a full-close position when the latch meshing with the striker is arranged at a predetermined primary latch position;
a secondary pawl (the secondary pawl 23) that engages with the latch to maintain the front hood at a half-engaged position when the latch is released from an engaged state with the primary pawl is arranged at a predetermined secondary latch position;
a motor (the electric motor 41); and
a driving force transmission member (the open lever 35) that operates by driving the motor and is capable of releasing the engaged state between the latch and the primary pawl and an engaged state between the latch and the secondary pawl, in which
the latch device is configured to perform, by driving the motor, a power release function of releasing the engaged state between the latch and the primary pawl and the engaged state between the latch and the secondary pawl using the driving force transmission member to switch the front hood from the full-close position to a full-open position, and
a closer component mounting portion is provided between the driving force transmission member and the latch, the closer component mounting portion being capable of mounting a closer component thereon that allows the latch device to perform, by driving the motor, a closer function of moving the front hood from the half-engaged position to the full-close position.

According to (1), since the latch device of the power release function is provided with the closer component mounting portion, it is possible to select, depending on whether the closer component is mounted, a specification (that is, the power release specification) having the power release function but not having the closer function or a specification (that is, the closer and power release specification) having the closer function and the power release function. In any of the specifications, components other than the closer component are shared, and thus the latch device can handle the specification change between the power release specification and the closer and power release specification at a low cost.

(2) The latch device for a front hood according to (1), further including:
the closer component that is removably mounted on the closer component mounting portion, in which
the latch device is configured to perform the power release function and the closer function.

According to (2), the latch device can have the closer and power release specification by mounting the closer component. Further, the closer and power release specification can be changed to the power release specification only by removing the closer component from the closer component mounting portion.

(3) The latch device for a front hood according to (1) or (2), in which
the closer function is a function of moving the front hood from the half-engaged position to the full-close position by driving the motor based on a detection result of a first sensor (the primary pawl sensor 52 and the primary detection magnet 22f) that detects a position of the primary pawl and a detection result of a second sensor (the secondary pawl sensor 53 and the secondary detection magnet 23f) that detects a position of the secondary pawl, and
the latch device further includes a sensor mounting portion (the sensor mounting portion 51a, the magnet mounting portion 22f1, the sensor mounting portion 52a, and the magnet mounting portion 23f1) capable of mounting the first sensor and the second sensor thereon.

According to (3), in a case where the latch device is set to the power release specification, the state of the latch can be reliably grasped by the first sensor and the second sensor when the first sensor and the second sensor are mounted to the sensor mounting portion, and the manufacturing cost of the latch device of the power release specification can be further reduced when the first sensor and the second sensor are not mounted to the sensor mounting portion.

(4) The latch device for a front hood according to any one of (1) to (3), further including:
a housing (actuator housing 40H) accommodating the motor, in which
the closer component mounting portion overlaps with a surface (the surface 40s) having a maximum projected area among surfaces of the housing.

According to (4), even when the closer component is mounted on the closer component mounting portion, an increase in size of the latch device can be prevented.

(5) The latch device for a front hood according to (4), in which
when the closer component is mounted on the closer component mounting portion, the entire closer component overlaps with the surface having the maximum projected area among the surfaces of the housing.

Accordingly to (5), even when the latch device is of the closer and power release specification, the size of the latch device is the same as that of the latch device of the power release specification, and thus it is not necessary to design and change the vehicle body portion on which the latch device is mounted according to the specifications of the latch device.

(6) The latch device for a front hood according to (2), in which
the closer component includes a link member (cinching lever 36) provided on the driving force transmission member and pressing the latch from the secondary latch position toward the primary latch position by driving the motor.

According to (6), since the closer component includes the link member, the closer component can be easily attached to the latch device. In addition, the retraction force for retracting the striker can be easily adjusted by appropriately changing the extension length of the link member.

(7) The latch device for a front hood according to (6), further including:
an emergency lever (emergency lever 24) that releases an engaged state between the link member and the latch when an operation force for an emergency is input thereto.

According to (7), even when the stacked state occurs in which the latch is at the primary latch position and the link mechanism and the latch are engaged with each other, the stacked state can be released by the operation of the emergency lever.

(8) The latch device for a front hood according to any one of (1) to (7), in which
the latch device is changeable between a power release specification only having the power release function and a closer and power release specification having the power release function and the closer function.

According to (8), it is possible to provide a latch device that can be changed to two specifications.

What is claimed is:

1. A latch device for a front hood, which is capable of meshing with a striker provided in the front hood of a vehicle and performing opening and closing control of the front hood, the latch device comprising:
a latch configured to mesh with the striker when the front hood is in a closed state and biased by a biasing member in a direction in which the latch is to be released from meshing with the striker;
a primary pawl configured to engage with the latch to maintain the front hood at a full-close position when the latch meshing with the striker is arranged at a predetermined primary latch position;
a secondary pawl configured to engage with the latch to maintain the front hood at a half-engaged position when the latch released from an engaged state with the primary pawl is arranged at a predetermined secondary latch position;
a motor; and
a driving force transmission member configured to operate by driving the motor and capable of releasing the engaged state between the latch and the primary pawl and an engaged state between the latch and the secondary pawl, wherein
the latch device is configured to perform, by driving the motor, a power release function of releasing the engaged state between the latch and the primary pawl and the engaged state between the latch and the secondary pawl using the driving force transmission member to switch the front hood from the full-close position to a full-open position, and
a closer component mounting portion is provided between the driving force transmission member and the latch, the closer component mounting portion being capable of mounting a closer component thereon that allows the latch device to perform, by driving the motor, a closer function of moving the front hood from the half-engaged position to the full-close position.

2. The latch device for a front hood according to claim 1, further comprising:
the closer component removably mounted on the closer component mounting portion, wherein
the latch device is configured to perform the power release function and the closer function.

3. The latch device for a front hood according to claim 1, wherein
the closer function is a function of moving the front hood from the half-engaged position to the full-close position by driving the motor based on a detection result of a first sensor configured to detect a position of the primary pawl and a detection result of a second sensor configured to detect a position of the secondary pawl, and
the latch device further comprises a sensor mounting portion capable of mounting the first sensor and the second sensor thereon.

4. The latch device for a front hood according to claim 1, further comprising:
a housing accommodating the motor, wherein
the closer component mounting portion overlaps with a surface having a maximum projected area among surfaces of the housing.

5. The latch device for a front hood according to claim 4, wherein
when the closer component is mounted on the closer component mounting portion, the entire closer component overlaps with the surface having the maximum projected area among the surfaces of the housing.

6. The latch device for a front hood according to claim 2, wherein
the closer component includes a link member provided on the driving force transmission member and configured to press the latch from the secondary latch position toward the primary latch position by driving the motor.

7. The latch device for a front hood according to claim 6, further comprising:
an emergency lever configured to release an engaged state between the link member and the latch when an operation force for an emergency is input thereto.

8. The latch device for a front hood according to claim 1, wherein
the latch device is changeable between a power release specification only having the power release function and a closer and power release specification having the power release function and the closer function.
